(19) United States
(12) Patent Application Publication
(10) Pub. No.: US 2013/0101264 A1
(43) Pub. Date: Apr. 25, 2013

(54) METHODS AND APPARATUS FOR CAPTURING AMBIENCE

(71) Applicants: Arend Jan Wilhelmus Abraham Vermeulen, Drachtster Compagnie (NL); Damien Loveland, Richmond (CA)

(72) Inventors: Arend Jan Wilhelmus Abraham Vermeulen, Drachtster Compagnie (NL); Damien Loveland, Richmond (CA)

(73) Assignee: Koninklijke Philips Electronics N.V., Eindhoven (NL)

(21) Appl. No.: 13/805,686

(22) PCT Filed: Jun. 30, 2011
(86) PCT No.: PCT/IB2011/052604

§ 371 Date: Dec. 20, 2012

Related U.S. Application Data
(60) Provisional application No. 61/359,997, filed on Jun. 30, 2010.

(51) Int. Cl. H04N 5/77

(52) U.S. Cl. CPC H04N 5/77
USPC 386/225

(57) ABSTRACT

A mobile ambience capturing device (100, 200) and ambience capturing method (300) is described. The mobile ambience capturing device includes at least one sensing device (202) for sensing at least one stimulus in an environment (610), and an activity-determining device (206) for determining an activity carried out in the environment. The mobile ambience capturing device also includes a processor (112, 212) for associating the stimulus information with the activity, a memory (110, 210) for capturing information about the sensed stimulus, the activity, or the association between the stimulus information and the activity, and a transmitter (118, 218) for transmitting information about the stimulus, the activity, or the association for storage in a database (640). In some embodiments, the at least one sensing device is configured for sensing both a visual stimulus and a non-visual stimulus.

### TECHNICAL FIELD

The present invention generally relates to lighting systems and networks. More particularly, various inventive methods and apparatus disclosed herein relate to capturing stimuli information, including lighting ambience, from an environment with a mobile device.

### BACKGROUND

Digital lighting technologies, i.e. illumination based on semiconductor light sources, such as light-emitting diodes (LEDs), today offer a viable alternative to traditional fluorescent, HID, and incandescent lamps. Recent advances in LED technology coupled with its many functional advantages such as high energy conversion and optical efficiency, durability, and lower operating costs, has led to the development of efficient and robust full-spectrum lighting sources that enable a variety of lighting effects. For example, fixtures embodying these lighting sources may include one or more LEDs capable of producing different colors, e.g. red, green, and blue, as well as a processor for independently controlling the output of the LEDs in order to generate a variety of colors and color-changing lighting effects.

Recent developments in digital lighting technologies such as LED-based lighting systems have made the precise control of digital or solid-state lighting a reality. Consequently, existing systems for natural illumination based lighting control, occupancy-based lighting control, and security control are able to utilize digital lighting technologies to more precisely monitor and control architectural spaces such as offices and meeting rooms. Existing natural illumination based lighting control systems may, for example, comprise individually controllable luminaires with dimming or bi-level switching ballasts as well as one or more natural illumination photosensors to measure the average workplane illumination within a naturally illuminated space. In such systems, one or more controllers, in order to respond to daylight egress and maintain a minimum workplane illumination, may monitor the output of one or more photosensors and control illumination provided by the luminaires.

Further, existing controllable lighting networks and systems include lighting management systems that are capable of utilizing digital lighting technologies in order to control the lighting in one or more spaces. Controllable lighting networks and systems may control luminaires in a space based on the personal lighting preferences of individuals detected within or otherwise associated with a space. Many controllable lighting networks and systems utilize sensor systems to receive information about the spaces under their influence. Such information may include the identities of individuals detected within such spaces as well as the personal lighting preferences associated with such individuals.

Lighting systems have been disclosed wherein a person can input his or her lighting preferences for a specific location, and a central controller can execute a lighting script to instruct LEDs or other light sources and implement the person's preferences. In one disclosed system, lighting systems may receive inputs indicating the presence of a person, the duration of the person's presence, or identifying the presence of a particular person or persons present in the location by, for example, the magnetic reading of name badges or a biometric evaluation. Disclosed systems may then implement different lighting scripts depending upon whether a person is present, how long the person is present, and which person is present. These systems may also select different lighting scripts depending on the number of persons in a room or the direction the people are facing. In one disclosed system, lighting devices and other energy sources are turned on or off depending on information in a person's electronic calendar.

Although the fields of mobile devices and digital or solid-state lighting have seen great advances, systems that combine the use of controllable lighting with capabilities of personal mobile devices to further enrich deriving personal lighting preferences and adjusting lighting based on personal preferences across a plurality of lighting networks are lacking. For example, in systems implementing user preferences, a user's preferences generally (1) need to be initially manually entered for every single variable that may be adjusted and (2) are specific to a particular location and not executable in a different location or in different networks. Therefore, one common disadvantage of these systems is the need for a particular person's lighting preferences to be programmed by an administrator or after being given access by an administrator. A person's preferences must be programmed separately for each location visited or frequented. Alternatively, lighting technologies have been disclosed which enable each user to program his or her preferences only once, so that they can be accessed and used by multiple, isolated lighting networks. Examples of such lighting systems are described in the international application Serial No. PCT/IB2009/052811, incorporated herein by reference.

The existing technologies, thus, generally associate a lighting arrangement with a user and possibly with a location. The existing technologies, however, cannot choose or recommend lighting arrangements of one user to a different user who has not entered that lighting arrangement in his or her user preferences.

The existing technologies, further, capture the ambience of an environment merely through visual stimuli, e.g., lighting intensity or lighting color combination. These technologies do not capture the non-visual aspects of the ambience related to non-visual stimuli including, e.g., sounds or smells. When a user attends a location, e.g., a restaurant, and enjoys the overall ambience of that location, e.g., the combination of the lighting and the music, the user may wish to capture both visual and non-visual aspects of the ambience, such that the user can re-create both aspects of the ambience in a different location.

### SUMMARY

Applicants have recognized that there is a need to enable a user to capture both visual and non-visual aspects of the ambience of an environment using a portable device and then recreate the captured ambience elsewhere as a combination of some of the visual aspects, e.g., lighting, and some of the non-visual aspects, e.g., music.

Further, Applicants have recognized that, when capturing an ambience of an environment, there is a need for determining the activity performed in the environment and for associating the ambience with that activity. Such association enables some embodiments of the invention to determine that the activities associated with two separate environments are similar, and to offer to a user the ambience of the first environment, when the user attends the second environment. Such offering may be made even if the ambience of the first environment has not been saved under the user's preferences at all, or has been saved under the user's preference only for the first environment.

Embodiments of the invention include a mobile ambience capturing device. The mobile ambience capturing device includes at least one sensing device for sensing at least one stimulus in an environment, an activity-determining device for determining an activity carried out in the environment. The mobile ambience capturing device also includes a processor for associating the stimulus information with the activity, a memory for capturing information about the sensed stimulus, the activity, or the association between the stimulus information and the activity, and a transmitter for transmitting information about the stimulus, the activity or the association for storage in a database.

In some embodiments, the at least one sensing device is configured for sensing both a visual stimulus and a non-visual stimulus.

In some other embodiments, the activity-determining device is configured to derive a venue type of the environment using information about a location of the environment received by a GPS receiver of the mobile device and venue mapping information, and to determine the activity carried out in the environment from the venue type of the environment. The venue mapping information associates a plurality of locations with a plurality of venue types.

Other embodiments of the invention include an ambience capturing method which includes capturing information about at least one stimulus in an environment, sensed by at least one sensing device of a mobile device, using a memory of the mobile device. The ambience capturing method also includes determining, by an activity-determining device in the mobile device, an activity carried out in the environment as the stimulus information is captured, associating, by a processor in the mobile device, the activity with the stimulus information, and transmitting the activity and the associated stimulus information for storage in a database.

“Activity,” as used herein, should be understood as a type of activity that is generally carried out at a venue environment or a type of activity carried out by a specific user in the environment. The type of activity generally carried out in a venue environment may be determined from, for example, the type of business located at the venue environment, e.g., a restaurant, a dancing parlor, or a sports bar. The type of activity carried out by a user may be determined from, for example, the reading of an accelerometer or an orientation sensor on the user's mobile device showing that, e.g., the user is dancing, sitting, or lying down.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

The term “controller” or “lighting control system” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrate a mobile device utilized by a user as an ambience capturing device according to some embodiments.

FIG. 2 illustrates a block diagram of an ambience capturing device according to some embodiments.

FIG. 3 illustrates a capturing/associating flow chart according to some embodiments.

FIG. 4 illustrates an ambience capturing flow chart according to some embodiments.

FIG. 5 illustrates a user interface for an ambience capturing device according to some embodiments.

FIG. 6 illustrates an ambience capturing/recreating system including a mobile ambience-capturing device according to some embodiments.

FIG. 7 illustrates an ambience recreating flow chart according to some embodiments.

### DETAILED DESCRIPTION

Reference is now made in detail to illustrative embodiments of the invention, examples of which are shown in the accompanying drawings.

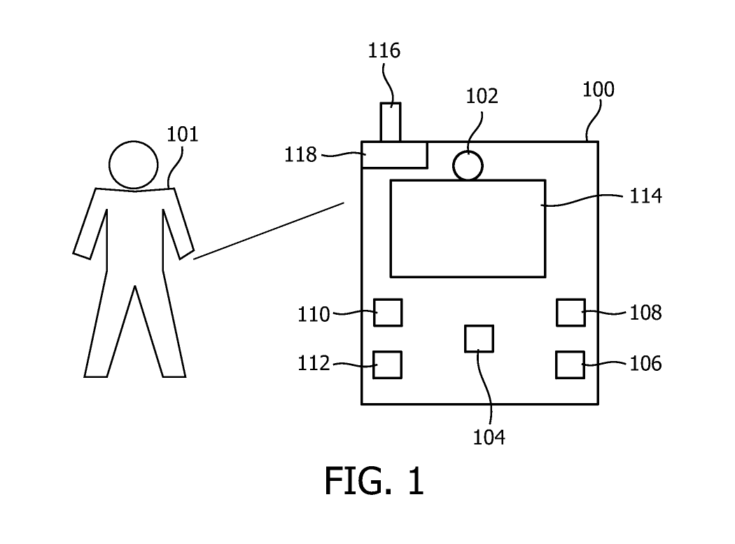

FIG. 1 illustrate a mobile device 100 according to some embodiments. In some embodiments, user 101 utilizes mobile device 100 as an ambience capturing device. In some embodiments, mobile device 100 can be an enhanced mobile phone which has been equipped with additional software applications or hardware equipment for capturing information about ambience of an environment and/or for determining an activity performed in that environment, as detailed below. In other embodiments, mobile device 100 can be a personal digital assistant (PDA), a Bluetooth transceiver, e.g., a Bluetooth headphone, a personal camera, or a portable computer, each being similarly enhanced.

As illustrated in FIG. 1, mobile device 100 includes three sensing devices, i.e., a camera 102, a microphone 104, and an accelerometer 106. Mobile device 100 also includes a data-collecting devices, i.e., a GPS receiver 108. Also, mobile device 100 includes a memory 110, a microprocessor 112, a user interface 114, an antenna 116, and a transceiver 118.

Camera 102 can take still images or video clip images of the environment. Microphone 104, on the other hand, can receive sounds in the environment and send those sounds to a sound recorder in mobile device 100 to be recorded. Different sound recordings may span different lengths of time, e.g., a fraction of a second or a few seconds.

GPS receiver 108 is a receiver which communicates with a global positioning service (GPS) system to receive information about the location of the environment in which mobile device 100 is located. The location information can be, for example, in the form of positional coordinates. In some embodiments, GPS receiver 108 also receives, either from the GPS system or from memory 110, some venue mapping information which associate positional coordinates or locations on a map with venue types that exist at those locations, e.g., the location of restaurants, shops, lecture halls, libraries, or other types of venues.

Accelerometer 106 can sense the motion status of mobile device 100. Specifically, accelerometer 106 may determine the acceleration by which the mobile device 100 is moving in some direction, e.g., whether it is moving back and forth. Accelerometer 106 may determine the motion status by, for example, using mechanical mechanisms installed in mobile device 100 or using time dependent changes in location information received by GPS receiver 108.

Memory 110 is a storage medium used for capturing information sensed by the sensing devices and also other related information, e.g., activity, as explained below. Memory 110 can also be used to store programs, or applications, utilized by microprocessor 112. Microprocessor 112 runs programs stored in memory 110 for analyzing information captured in memory 110 as explained in more detail below.

User interface 114 can be used by mobile device 100 to present to user 101 the captured information, or to receive an input from user 101 to accept, reject, edit, save in memory 110, or transmit to a network the captured information.

Antenna 116 is connected to, and cooperates with, transceiver 118 to transmit the captured information through the network, for the information to be stored in a remotely located database, or to be further analyzed and utilized by a remotely located server, as described below in more detail. Transceiver 118, in general, can include a transmitter device for transmitting information to the network and a receiver for receiving information from the network. Embodiments of transceiver 118 can be implemented as hardware or software, or a combination of hardware and software, for example, a wireless interface card and accompanying software.

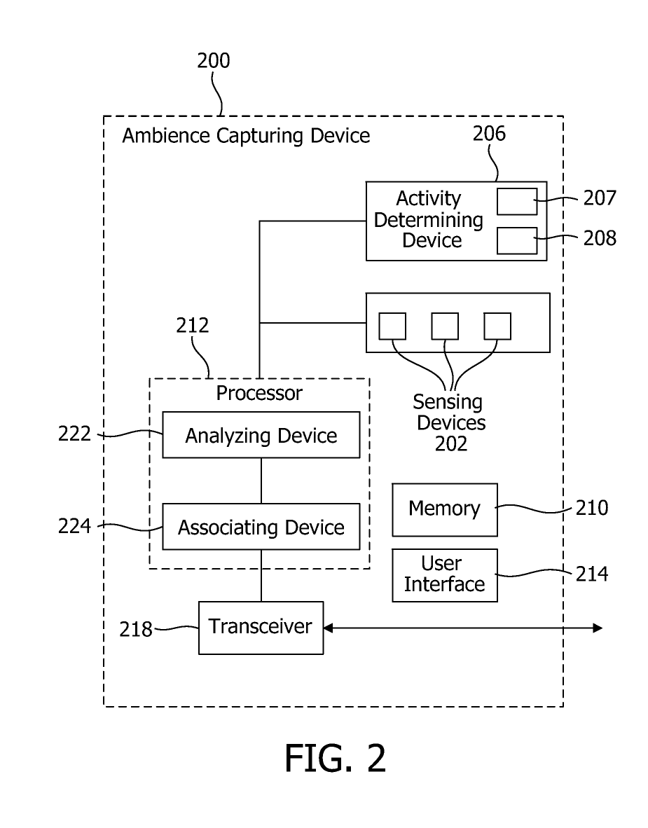

FIG. 2 illustrates a block diagram of an ambience-capturing device 200 according to some embodiments. In some embodiments, device 200 can be the mobile device 100 illustrated in FIG. 1. In some other embodiments, ambience-capturing device 200 can be a dedicated device, carried by the user, specifically designed for capturing information about ambience of an environment and/or for determining an activity performed in that environment, as detailed below.

In some embodiments, device 200 includes one or more sensing devices 202, one or more activity-determining devices 206, a memory 210, a processor 212, a user interface 214, and a transceiver 218.

Sensing devices 202 are sensors which sense one or more stimuli in the environment and accordingly generate one or more signals to be transmitted to processor 212 for further analysis or to memory 210 for storage. Sensing devices 202 can include, for example, camera 102 for detecting visual stimuli or microphone 104 for detecting audio stimuli. In some embodiments, device 200 also includes other sensing devices for detecting other stimuli, e.g., a thermometer for detecting the temperature, or a photometer or a photosensor for detecting the intensity or color content of light. The intensity or color content of light can also be derived from the images taken by camera 102, as detailed below.

Activity-determining device 206 is a device for determining the activity. In some embodiments, activity-determining device 206 includes one or more data-collecting devices 207, which collect data used for determining the activity. Data-collecting device 207 can be, for example, GPS receiver 108 or accelerometer 106. In some embodiments, activity-determining device 206 includes other data-collecting devices, e.g., a compass for determining the direction to which device 200 points, an orientation sensor for determining the orientation of device 200 (e.g., held vertical or horizontal), a speedometer for determining the speed of device 200 using, e.g., data from GPS receiver 108, or a clock for determining the capturing time, that is, the specific moment or period of time during which the stimuli or activity information is captured. In some embodiments, activity-determining device 206 includes more than one accelerometers, each for determining the motion status of device 200 along one of multiple directions. Also, activity-determining device 206 may include a rotational accelerometer for sensing the angular acceleration of device 200 in a rotational motion around one or more axes.

In some embodiment a sensing device 202 can be a data-collecting device. That is, to determine the activity, activity-determining device 206 may use information collected by a sensing device 202, e.g., images taken by camera 102, sounds recorded through microphone 104, or the acceleration measured by accelerometer 106.

Activity-determining device 206 may also include a data-analyzing device 208, in the form of a dedicated hardware or a software module running on processor 212. Data-analyzing device 208 analyzes information gathered by data-collecting device 207 to determine the activity.

Memory 210 is a storage medium used for capturing information related to the stimuli as sensed by sensing devices 202 and/or information about the activity as determined by activity-determining device 206. Memory 210 may also store programs run by processor 212.

Processor 212 is a processor which, for example, runs one or more programs stored in memory 210 to analyze stimulus related signals received from sensing devices 202 or data collected by data-collecting device 207. In some embodiments, processor 212 includes microprocessor 112 of mobile device 100. In some embodiments, processor 212 includes an analyzing device 222 and an associating device 224. Each of analyzing device 222 and associating device 224 can be implemented as a dedicated hardware, a software module executed by processor 212, or a combination of hardware and software.

Analyzing device 222 also uses stimuli information, as reflected in signals received from sensing devices 202, to derive information representing the stimuli and store that information in memory 210. In some embodiments, analyzing device 222 also includes data-analyzing device 208. That is, analyzing device 222 receives information gathered by data-collecting device 207 and analyzes that information to determine the activity.

Associating device 224 receives information representing the stimuli and information representing the determined activity, and associates those information to derive an association between the ambience of the environment or the activity performed in the environment.

User interface 214 is a user interface used by device 200 to present to user 101 the information representing the stimuli, the activity, or the association between those information, and to receive an input from user 101 to accept, reject, edit, save in memory 210, or transmit to a network those information or the association. In some embodiments, user interface 214 includes user interface 114 of mobile device 100.

Transceiver 218 is used by device 200 for transmitting information to and receiving information from a network. In some embodiments, transceiver 218 includes transceiver 118 of mobile device 100. In some embodiments, transceiver 218 communicates with the network, for example, via wireless, wire/cable, and/or fiber optic connections.

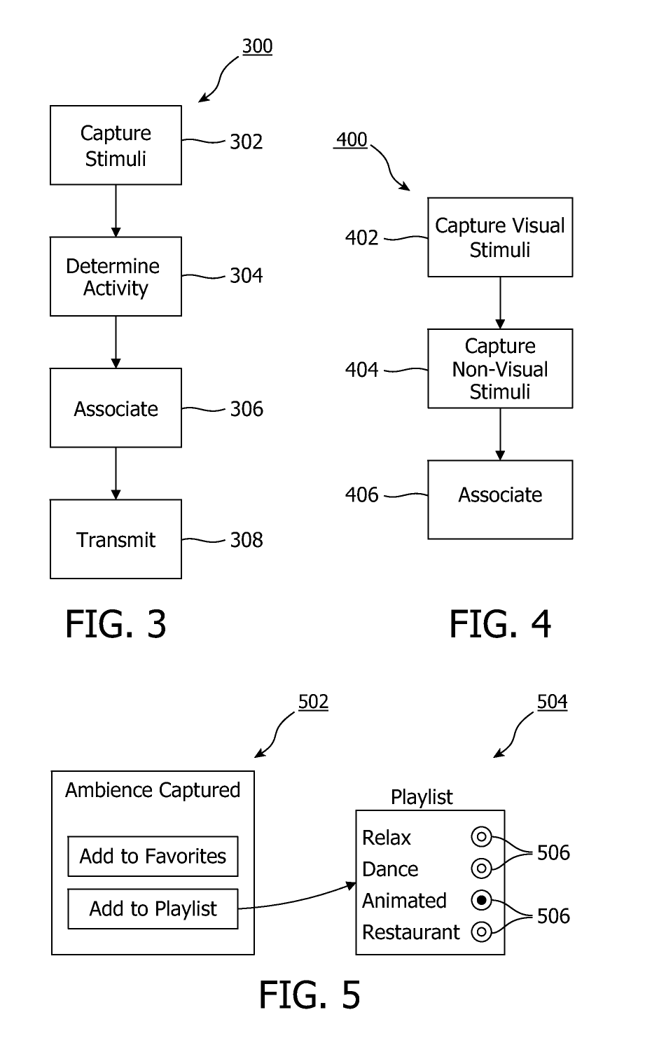

FIG. 3 illustrates a flow chart 300 of a process that may be performed for example by device 200 according to some embodiments. Flow chart 300 features four steps: in step 302, stimuli is captured; in step 304, activity is determined; in step 306, ambience is associated with activity; and in step 308, information is transmitted to a remote database. Steps of flow chart 300 are described in more detail below.

In step 302, device 200 captures information about one or more stimuli sensed by one or more sensing devices 202. As part of step 302, sensing device 202 senses the stimulus in the environment and sends signals to analyzing device 222 of processor 212. Analyzing device 222 analyzes those signals and derives information representing the stimuli and stores that information in memory 210. A combination of the information about one or more stimuli represents the ambience that may be captured, for example, by device 200.

According to some embodiments, analyzing device 222 may analyze still images taken by camera 102 to determine some visual aspects of the ambience, e.g., the level of brightness or the color content in the lighting. In some embodiments, analyzing device 222 analyzes images to determine an average color content for the whole field of view, or color contents averaged for constituent spatial zones. Analyzing device 222 may, for example, divide the field of view into an upper portion and a lower portion, distinguishing the upper and the lower portions based on a reading from an orientation sensor included in mobile device 100.

According to some embodiments, analyzing device 222 may additionally or alternatively analyze a video clip recorded by camera 102. Analyzing device 222 may analyze the video clip for the presence of people and their potential activities, or for the presence of TV displays or other screens. Analyzing device 222 may also analyze screens captured in the video clip for the type of content, such as sports, music, news, wildlife, reality show.

Similarly, in some embodiments, analyzing device 222 may additionally or alternatively analyze sound recordings recorded through microphone 104 to determine, for example, the volume level of sounds, existence of music or speech among the recorded sounds. Analyzing device 222 may analyze the sounds for music content to identify, e.g., the genre of the music or the particular song or track in the recorded music. Analyzing device 222 may also analyze the sounds for the level of conversation and, for example, whether there is anyone talking, whether there is a conversation, whether there is a group discussion, whether there is a noisy crowd, or whether anyone is singing. Analyzing device 222 may also record keywords picked out from a conversation as representing moods of the conversant. Further, in some embodiments, analyzing device 222 may also determine the number of people in proximity of user 101, e.g., by analyzing a sequence of video frames taken by camera 102, or by determining the number of different human voices recorded via microphone 104. People in proximity of user 101 may be defined as, for example, those people that are within a specific distance, e.g., five yards, to, or those that can directly converse with, user 101.

In some embodiments, as part of step 302, analyzing device 222 formats the derived data in an ambience table to be saved to a database stored in memory 210 or to be transmitted to be saved in a database of a remote server. Table 1 illustrates an exemplary ambience table, which is created in step 302, in accordance with some embodiments.

TABLE 1

| Ambience | | Lighting | Lighting | Music | Music | Captured screen |
|---|---|---|---|---|---|---|
| ID | User ID | RGB | brightness % | genre | volume | theme |
| a1b2 | Jip | 23EE1A | 56 | Rock | Very loud | None |
| a1c3 | Jip | A2E42A | 77 | Jazz | Medium | Instruments |
| q1g6 | Janneke | FF00D2 | 81 | Pop | Loud | Sport |

Table 1 features three data rows and seven columns. Each data row corresponds to an ambience captured for example by one or more mobile devices 100, or one or more devices 200, used by one or more users 101. The first column, titled Ambience ID, assigns a unique identification to each of the three ambiences. The second column, titled user ID, features an identification, in this case the first name, of the user associated with each of the three ambiences. The user associated with each ambience may be the user who captures the ambience. Alternatively, the user associated with an ambience may be a user who connects to a server on which the ambience information is saved and selects that ambience to be recreated in an environment attended by the user. The third to seventh columns each feature a characteristic of some stimuli in the corresponding ambience. Specifically, the third, fourth and seventh columns each characterize visual stimuli in the environment, while the fifth and sixth columns each characterize audio stimuli in the environment.

In Table 1, values in the third column, titled “Lighting RGB”, indicate the average color content in the lighting. Values in the fourth column, titled “Lighting brightness”, indicate the level of brightness in the lighting in the environment recorded in the form of a percentage value compared to the maximum possible brightness. Values in the seventh column, titled “Captured screen theme”, indicate the theme of the screen captured by camera 102. Analyzing device 222 may derive values in the third, fourth, and seventh columns from one or more still images or a video clips taken by camera 102, or from measurements made by a photometer or a photosensor.

Values in the fifth and sixth columns respectively indicate the genre and the volume level of a music played in the environment. Analyzing device 222 may derive values in these columns from one or more sound recordings made through microphone 104. Analyzing device 222 may first detect presence of music in the sound recordings, and then analyze the detected music to determine the genre of that music as, e.g., rock, jazz, or pop. Similarly, analyzing device 222 may determine the volume level of the detected music and categorize and save it in Table 1 as, e.g., low, medium, loud, or very load.

As seen in Table 1, the data may be stored numerically, e.g., as a percentage as in column four, in hexadecimal format, as in column three, or using descriptor words, as in columns five to seven.

In some embodiments, as part of step 302, analyzing device 222 captures both visual and non-visual, e.g., audio, stimuli and associates those stimuli as characteristics of one ambience. As an example, FIG. 4 illustrates an ambience capturing flow chart 400 according to some embodiments. As seen in flow chart 400, in step 402 device 200 captures information about visual stimuli, e.g., lighting intensity, through one or more sensing devices 202. Further, in step 404, device 200 captures information about non-visual stimuli, e.g., music type, through one or more sensing devices 202. In step 406, device 200 associates the captured visual and non-visual stimuli as parts of the same ambience as, for example, reflected in Table 1, columns one and three to seven.

In step 304 of flow chart 300, activity-determining device 206 determines the activity performed in the environment. Specifically, in step 304, one or more data-collecting devices 207 collect data used for determining the activity. Further, in step 304, data-analyzing device 208 analyzes data collected by data-collecting device 207 and determines the activity.

In some embodiments, in step 304, GPS receiver 108 collects data indicating the location of the environment. In some such embodiments, data-analyzing device 208 determines a venue type of the environment. A venue type may be determined, for example, by looking up the location data on a venue type mapping, which may be received by GPS receiver 108 from a GPS system and/or may be stored in memory 210, for example, from a mapping service. For example, data-analyzing device 208 may determine that the positional coordinates of the environment matches, in the venue mapping information, the positional coordinates of a restaurant. Data-analyzing device 208, thus, determine that the environment attended by user 101 is a restaurant and further, combining this information with a clock reading, determine that the activity performed in the environment is having lunch or having dinner. Similarly, data-analyzing device 208 may determine that the environment is located in a pub, a shopping mall, a hotel, a lecture room, a convention centre, or a theatre, and accordingly determine the activity at the capturing time.

In some embodiments, in step 304, accelerometer 106 collects data about the motion status of device 200 at the capturing time. Data-analyzing device 208 may use this information separately or as combined with other information collected by other data-collecting devices 207, e.g., an orientation sensor in device 200. Data-analyzing device 208 uses this data to determine the activity of user 101. For example, data-analyzing device 208 may use motion information gathered over an extended period of time and saved in a table stored in memory 210 to correlate detected user motions with a specific activity with identifiable motion signatures. Activities which have identifiable motion signatures may include lying down, standing, sitting, walking, running, dancing, presenting, drinking, eating etc.

In some embodiments, in step 304, data-analyzing device 208 combines data collected by one or more data-collecting devices 207 and data collected by one or more sensing devices 202 to determine the activity. For example, data-analyzing device 208 may compare the timing and rhythm of the music recorded through microphone 104 with data about the timing and the rhythm of the motion of use 101 collected by accelerometer 106 to determine that, at the capturing time, user 101 was dancing with the music.

In some embodiments, data-analyzing device 208 determines the activity to be one of a list of activities pre-stored in memory 210. The pre-stored list of activities may, for example, be stored in the form of an activity table. Table 2 illustrates an exemplary activity table.

TABLE 2

| Activity | | Motion | Capturing |
|---|---|---|---|
| keyword | Venue type | status | time |
| eating lunch | Restaurant | Sitting | 11AM-2PM |
| dancing | Dance Parlor | Standing; moving | Any |
| | | in sync with music | |
| Watching TV | Pub | Sitting | Any |
| Resting | Home | Lying down | 9PM-7AM |

Table 2 features four data rows and four columns. Each data row corresponds to an activity. The first column, titled Activity keyword, assigns a unique keyword to each of the activities. In some embodiments, activity keywords are keywords that uniquely identify each activity for device 200. In some other embodiments, activity keywords are also unique among all ambience-capturing device 200 which are in communication with an ambience capturing server.

The second to fourth columns in Table 2, identify one or more characteristics of the corresponding activity as collected by data-collection device 207. Specifically, in the example of Table 2, second to fourth columns respectively correspond to venue type, motion status, and capturing time. Therefore, for example the first row in Table 2 indicates that for the activity identified by the keyword “eating lunch,” the venue type is “Restaurant”, the motion status is “sitting” and the capturing time is between 11 AM and 2 PM. In some other embodiments, Table 2 may include other columns which identify the activity by other characteristics of the activity. In some embodiments, data-analyzing device 208 compares data collected by one or more data-collecting devices 207 with characteristics of each data row in Table 2, and determines the activity if it finds some level of a match. Further, in some embodiments, instead of an activity keyword, each activity is identified by a unique activity identification.

In step 306, associating device 224 associates the ambience captured in step 302 with the information about the activity determined in step 304 and stores that association in memory 210 and/or transmits that associated information via transceiver 218 to a remote database. In some embodiments, as part of step 306, associating device 224 formats the association between the ambience and the activity in an association table to be saved to a database stored in memory 210 and/or to be transmitted for storage in a database of a remote server. Table 3 illustrates an exemplary association table which may be created in step 306, in accordance with some embodiments.

TABLE 3

| Ambience ID | Activity keyword |
|---|---|
| a1b2 | Dancing |
| a1c3 | Sitting |
| q1g6 | Conversation |

Table 3 features three data rows and two columns. Each data row corresponds to one of the ambiences recorded in Table 1. The first column, titled Ambience ID, identifies the ambience, as captured in step 302 and as recorded in Table 1. The second column, titled Activity keyword, features the activity keyword which identifies the activity as determined by data-analyzing device 208 in step 304. Table 3 thus associate each ambience with an activity.

Device 200 may automatically associate an ambience with an activity, to store the ambience, the activity, or the association in memory 210 and/or to transmit that information to a remote server. Alternatively, device 200 may present the captured information and/or the association to user 101 and receive input from user 101 to either edit, save, or delete the information and/or the association. FIG. 5 illustrates exemplary screens shown on user interface for an ambience capturing device according to some embodiments.

FIG. 5 illustrates an exemplary message screen 502 and an exemplary playlist screen 504 such as may displayed, for example, on user interface 214 of device 200. Message screen 502 indicates that ambience of the environment has been captured and displays two options: (1) adding the captured ambience to a favorites table and/or (2) adding the captured ambience to a playlist. If user 101 selects the “Add to Favorites” option, user interface may allow user 101 to enter a name, e.g., “soothing”, for the captured ambience and save, under that name, the characteristics of the captured ambience in a “favorites” table which indicates user 101's favorite ambiences. In saving those characteristics, device 200 may use a format similar to the format shown in one of the rows of Table 1. The favorites table may be stored locally in memory 210 of device 200 or remotely in a remote database.

If user selects the “Add to Playlist” option, user interface 214 displays playlist screen 504. Playlist screen 504 illustrates four predefined playlists named Relax, Dance, Animated, and Restaurant, each of which indicating a category of ambiences already defined by user 101 or by a remote server. User 101 may select to save the captured ambience under one of these categories by clicking on the radio button 506 corresponding to that category. User 101 may also rate the captured ambience or its association with an activity, e.g., on a scale of 1 to 10. Such ratings may later be used when recreating an ambience for user 101 or for another user.

In some embodiments, message screen 502 of user interface 214 also displays other options, which may allow the user to ignore and not save the captured ambience, and/or to edit the information about the captured ambience, e.g., by editing one or more entries in Table 1, before or after saving the ambience information.

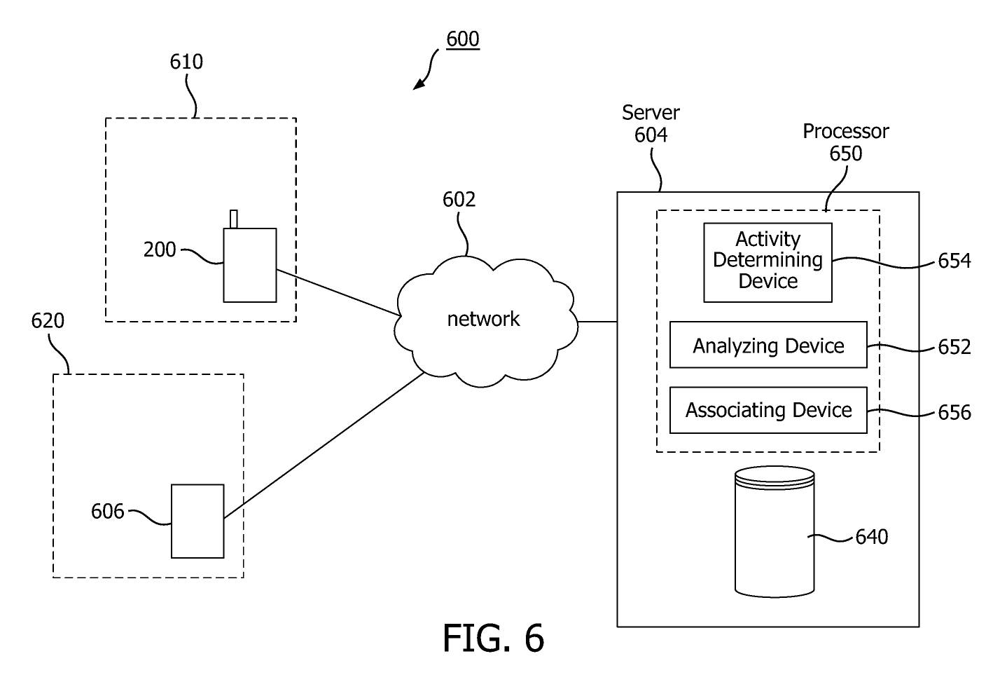

Once an ambience is captured in one environment and is stored in the favorites table or in the playlist and/or transmitted to a remote database, that ambience information may be retrieved, either from memory of 200 or from a remote database to which it was transmitted, for recreation of at least one aspect of the ambience in a different environment. FIG. 6 illustrates an ambience capturing/recreating system 600 according to some embodiments.

Ambience capturing/recreating system 600 includes an ambience-capturing device 200, a network 602, a server 604, and a controller device 606. Device 200 transmits to server 604 through network 602, information about the ambience, or the activity, at a first environment located at location 610. Server 604, analyzes or stores the received information. Server 604 also later transmits the stored information, through network 602, to controller device 606 which controls the ambience in a second environment located at location 620. Controller device 606 then recreates at least one aspect of the ambience of the first environment in the second environment.

In FIG. 6, a device such as mobile device 100 or device 200 may capture the ambience and determine the activity at a capturing time in a first environment which is located at location 610. The device such as device 100 or device 200 may also associate the captured ambience and the activity, as discussed in relation to flow chart 300.

The device may then transmit the captured information and association to server 604 through network 602, as described in step 308 of flow chart 300. In some embodiments, the device merely transmits the captured stimulus information or data collected related to the activity, and server 604 analyzes those stimulus information or collected data, and derives the associations. The device, or server 604 may assign an ambience identification, e.g., “ambience-A,” to the captured ambience.

Server 604 can be, for example, a computer system adapted to receive information from one or more devices such as device 200, to analyze and store that information, and to transmit information to one or more controller devices 606. As illustrated in FIG. 6, server 604 may include a database 640 and a processor 650. Database 640 may be stored, for example, in a storage device of server 604. Database 640 may store information about ambiences, users, activities, or associations, as received from one or more devices 200. The information may be directly received from one or more devices such as device 200 or may be derived by processor 650.

As illustrated in FIG. 6, processor 650 may include an analyzing device 652, an activity-determining device 654, and a associating device 656. Each of these devices may be implemented using a dedicated hardware, or a software module running on processor 650. Analyzing device 652 may analyze stimuli information received from one or more devices 200 and may derive information about the ambience of the corresponding environment. In some embodiments, analyzing device 652 uses a process similar to that described in relation to analyzing device 222 of device 200. Activity-determining device 654 may determine an activity performed in an environment located, for example, at locations 610 or 620, and stores that information in database 640. To that end, in some embodiments, activity-determining device 654 analyzes data collected by one or more devices 200, in a manner similar to that discussed in relation to activity-determining device 206 of device 200. Associating device 656 associates information about the stimuli and the activity, as received from device 200, or as analyzed and determined by analyzing device 652 and activity-determining device 654.

At a time after the capturing time, user 101 or another user may attend the second environment at location 620 and may wish to recreate at least one aspect of ambience-A in the second environment, that is, recreate in the second environment the at least one aspect of the ambience captured at the capturing time in the first environment located at location 610. To that end, user 101 may select ambience-A from a favorite list or a playlist of user 101, as stored in the device, or in server 604.

Alternatively, server 604 may determine that ambience-A must be recreated in the second environment, because same user is attending both environments, or because the activity performed at the two environments are identical or are similar.

For example, location 610 may be the living room of user 101 and the activity at that location at the capturing time may be determined to be watching TV. Location 620 may be a hotel room. When user 101 goes to the hotel room at location 620 and starts watching the TV, a device such as device 100 or device 200 carried by user 101 may automatically send server 604 information about the venue or the activity at location 620. Alternatively, user 101 may cause a device such as device 100 or device 200 to send this information to server 604 in order to adjust the ambience at location 620. Upon receiving the information, server 604 may determine that ambience-A must be recreated in the second environment, because the type of environment (living room versus hotel room) are similar or because the activities are identical (watching TV). Upon such determination, server 604 transmits to controller device 606 information indicative of ambience-A. Alternatively, user 101 may directly select ambience-A from a playlist or favorite list and send a request to system 600 to recreate that ambience at location 620. At this point, server 604 may transmit to controller device 606 a request to recreate ambience-A and also information about ambience-A. The transmitted information may be, for example, similar to the information in one or more of columns three to seven of Table 1.

Controller device 606 can include a lighting controller, which controls the lighting system at location 620. Further, controller device 606 can include audio-controllers which control non-visual stimuli at location 620, e.g., by playing a music on a sound system at location 620. Controller device 606 can also include controllers which control other types of stimuli, e.g., temperature or fragrances, at location 620. Upon receiving the request and the information from server 604 about ambience-A, controller device 606 recreates ambience-A at location 620 by adjusting stimulus creating instruments at location 620.

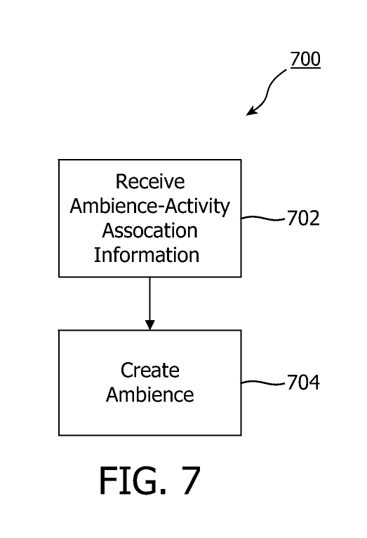

FIG. 7 illustrates an ambience recreating flow chart 700 as performed by controller device 606 according to some embodiments. In step 702, controller device 606 receives information about ambience-A from server 604, through network 602.

In step 704, controller device 606 sends signal to adjust various stimulus creating instruments at location 620 to recreate ambience-A. For example, controller device 606 may adjust the light emitted by lighting devices, e.g., luminaires, music played by audio devices, e.g., CD players, or temperature emitted by, e.g., heating systems, such that the visual or non-visual stimuli at location 620 assimilate one or more characteristics of ambience-A.

In some embodiments, system 600 is a system which includes an IMI (Interactive Modified Immersion) system. In an IMI system, a server communicates with one or more lighting controllers and thus controls the lighting in one or more environments. Further, a user present in an environment controlled by an IMI system can communicate with the IMI server via a user's mobile electronic device. If a user likes a particular lighting arrangement in an environment, the user can request the IMI server to flag the current lighting arrangement settings for future reference. Alternatively, the user can adjust the lighting arrangement in the user's environment, subject to the priorities and preferences of the other users present in the same environment. Further, the user has the option of communicating to the IMI system a message indicating that it should retrieve a previously flagged lighting arrangement to be recreated at the present environment. The IMI system, however, can only flag the lighting arrangement in an environment that is controlled by the IMI server. Also, the IMI system does not determine or use information about the activity performed in an environment. Further, the IMI system does not capture or recreate the full ambience, i.e., visual as well as non-visual characteristics, of an environment.

In system 600 illustrated in FIG. 6, server 604 may use an IMI server for controlling the visual stimuli at location 620. System 600, however, is also capable of receiving and analyzing information about non-visual stimuli and controlling those stimuli at location 620. Also, server 604 is capable of receiving or analyzing information about the activities in locations 610 and 620.

Further, in FIG. 6, while server 604 covers location 620, i.e., controls the ambience creating instruments at location 620, server 604 need not cover location 610. As described above, user 101 can capture information about the ambience and the activity at location 610 using a device such as mobile device 100 or device 200, and transmit that information to server 604. Server 604 can then cause controller device 606 to recreate that ambience at location 620. In some embodiments, server 604 recreates the ambience based on similarity between activities performed at the two locations. In some embodiments, server 604 uses a voting system to poll multiple users about their preferences of different captured ambiences and stores those ambiences along with the cumulative preferences in database 640.

In some embodiments, more than one user with different ambience preferences may be present at location 620. In such cases, server 604 may determine an ambience that is most similar to the preferred ambience of those users and recreate that ambience at location 620. Alternatively, server 604 may find an optimum ambience based on some priority information, according to which some of the users have a higher priority and thus their preferences is given a larger weight.

Server 604 may store data in database 640 to further analyze and derive preference rules for a group of people. Such data may be stored in a Preference database, or in a Schemata Marketplace. In some embodiments, server 604 combines data saved in a Schemata Marketplace with other preference data related to the snapshot of the ambience. For example, database 640 can include tables which store, not only different characteristics of each user's preferred ambience, or the related activity, but also additional information, e.g., the age group, and other personal preferences of each user, e.g., favorite food, favorite drink, or preferred hobby. In some embodiments, when a space owner or designer is looking to create an ambience that would attract people with a certain kind of interest, or of a certain demographic, the designer can utilize the information stored in database 640 about the ambience preferences of the target demographic to decide on an appropriate ambience. In some embodiments, cumulative preferences of a group of people, as stored in database 640, can indicate the preferences of that group. For example, a designer of a restaurant may use system 600 to design an environment in which the ambience of the restaurant or the ambience affecting a table changes based on the preferences of the patrons at that table or based on the overall ambience preferences of a group of people in an activity similar to that of those patrons. For instance, analyzing data in database 640 may indicate that most users prefer a specific setting for the lighting or the music when they drink some specific beverage. Thus, system 600 may accordingly adjust the lighting or music around a table, when patrons at that table are having that specific beverage

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Also, the phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited. Any reference numerals or other characters, appearing between parentheses in the claims, are provided merely for convenience and are not intended to limit the claims in any way. Finally, in the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. A mobile ambience capturing device, comprising:
at least one sensing device for sensing at least one stimulus in an environment;
an activity-determining device for determining an activity carried out in the environment;
a processor for associating the stimulus information with the activity;
a memory for capturing information about the sensed stimulus, the activity, or the association between the stimulus information and the activity; and
a transmitter for transmitting information about the stimulus, the activity or the association for storage in a database.

2. The mobile ambience capturing device of claim 1, wherein the at least one sensing device is configured for sensing both a visual stimulus and a non-visual stimulus.

3. The mobile ambience capturing device of claim 1, wherein the at least one sensing device is configured for sensing at least one of lighting brightness, lighting color, sound volume, music, voices, fragrance, and temperature.

4. The mobile ambience capturing device of claim 1, wherein the activity-determining device includes at least one of a GPS receiver, a venue detector for determining a venue type of the environment, a conversation-detector for detecting a level of conversation, a crowd-detector for determining a number of people present in a proximity of a user, a clock, an accelerometer for determining a motion status by the user, a thermometer, and an orientation detector for detecting an orientation of the user.

5. The mobile ambience capturing device of claim 1, wherein the activity-determining device is configured to derive a venue type of the environment using information about a location of the environment received by a GPS receiver of the mobile device and venue mapping information, wherein the venue mapping information associates a plurality of locations with a plurality of venue types; and to determine the activity carried out in the environment from the venue type of the environment.

6. The mobile ambience capturing device of claim 1, wherein the environment is a first environment and wherein the transmitter transmits the information to a controller device in a second environment, the controller device for controlling at least one stimulus in the second environment.

7. The mobile ambience capturing device of claim 1, wherein the processor is configured to analyze the information about the stimulus or information about the activity and associate the information about the stimulus with a user and wherein the transmitter is configured to transmit the association between the information about the stimulus and the user for storage in the database.

8. The mobile ambience capturing device of claim 1, wherein the transmitter transmits the information to a server for analyzing information about the at least one stimulus or information about the activity.

9. The mobile ambience capturing device of claim 1, further comprising a user interface for presenting to a user the information about the at least one stimulus and for receiving an input from the user to edit the information about the at least one stimulus or to transmit the information for storage in the database.

10. The mobile ambience capturing device of claim 1, wherein the mobile ambience capturing device is used by a first user of a plurality of users, the environment is a first environment of a plurality of environments each attended by at least one of the plurality of users, the information about the at least one stimulus is a first set of stimuli information of a plurality of sets of stimuli information sensed in the plurality of environments, and the activity is a first activity of a plurality of activities performed in the plurality of environments, and wherein the activity-determining device is further for determining the plurality of activities performed in the plurality of environments and the processor is for associating each set of the plurality of sets of stimuli information with a corresponding activity of the plurality of activities carried out in a corresponding environment of the plurality of environments.

11. An ambience capturing method comprising:
capturing information about at least one stimulus in an environment, sensed by at least one sensing device of a mobile device, using a memory of the mobile device;
determining, by an activity-determining device in the mobile device, an activity carried out in the environment as the stimulus information is captured;
associating, by a processor in the mobile device, the activity with the stimulus information; and
transmitting the activity and the associated stimulus information for storage in a database.

12. The ambience capturing method of claim 11, wherein capturing information about the at least one stimulus include capturing information about a visual stimulus as well as capturing information about a non-visual stimulus.

13. The ambience capturing method of claim 11, wherein capturing information about the at least one stimulus includes capturing information about at least one of lighting brightness, lighting color, sound volume, music, voices, fragrance, and temperature.

14. The ambience capturing method of claim 11, wherein determining the activity carried out in the environment includes receiving a GPS reading, determining a venue type of the environment by looking up venue mapping information, determining a level of conversation, determining a number of people present in a proximity of a user, receiving a clock reading, determining a motion status by the user from a reading by an accelerometer in the mobile device, sensing temperature, and determining an orientation of the user.

15. The ambience capturing method of claim 11, wherein determining the activity carried out in the environment comprises:
deriving a venue type of the environment using information about a location of the environment received by a GPS receiver of the mobile device and venue mapping information, wherein the venue mapping information associates a plurality of locations with a plurality of venue types; and
determining the activity carried out in the environment from the venue type of the environment.

16. The ambience capturing method of claim 11, wherein the environment is a first environment and wherein transmitting information includes transmitting the information to a controller device in a second environment, the method further comprising controlling at least one stimulus in the second environment by the controller device.

17. The ambience capturing method of claim 11, further comprising analyzing information about the stimulus or information about the activity.

18. The ambience capturing method of claim 11, wherein transmitting information includes transmitting the information to a server, the method further comprising analyzing, by the server, information about the at least one stimulus or information about the activity.

19. The ambience capturing method of claim 11, further comprising associating, by the processor, the information about the at least one stimulus with a user and transmitting the association between the information about the at least one stimulus and the user to the database.

20. The ambience capturing method of claim 11, further comprising presenting, via a user interface of the mobile device, to a user the captured information and receiving an input from the user to edit the captured information or to transmit the captured information for storage in the database.
